(19) United States
(12) Patent Application Publication
(10) Pub. No.: US 2008/0309121 A1
(43) Pub. Date: Dec. 18, 2008

(54) System for the reduction of aerodynamic drag on vehicles

(75) Inventor: Robert Edward Campbell, Gold Canyon, AZ (US)

Correspondence Address: Robert Edward Campbell, 7656 E Whispering Mesquite LN, Gold Canyon, AR, 85218-7105, US

(73) Assignee: Mr. Robert Edward Campbell, Gold Canyon, AZ (US)

(21) Appl. No.: 12/069,843

(22) Filed: Feb. 11, 2008

(51) Int. Cl. B62D 35/00

(52) U.S. Cl. 296/180.1

(57) ABSTRACT

The system is designed to reduce the aerodynamic drag on the box type of trucks such as semi-trailer or full truck vans. The system consists of a series of ductwork that gathers airflow from the front of the van and conducts the flow to the rear end of the van where it is released in proportional amounts at the back end of the truck, so as to alleviate the drag.

### BACKGROUND OF THE DESIGN CONCEPT

The concept of this design originated in the later 1970's and early 1980's. Due to the low cost of fuel, vehicle operators could only justify the cost over a long period of time. Now that fuel cost is anywhere from three to three and half-dollars per gallon, the cost can be justified in a much shorter time, in one or two years.

### SPECIFICATIONS

1. Materials:
   A) Aluminum sheeting, 040-gauge
   B) Half inch #7 hex head self-tapping screws.
   C) “S” clip joints (sheet metal workers term for a specific type of joint, available from materials suppliers). See item number three, Attachment A.
2. Struts are formed into “U” and “Z” shapes from ten-inch wide strips of the aluminum sheeting. See items number one and two, Attachment A.
3. The “U” shaped struts are attached to top of the van body along the out-side edges with screws spaced six inches on centers. See Attachment A, front view and plan or top view.
4. One “Z” shaped strut in place on center-line of the van body, with one “Z shaped strut placed equal distance between the center strut and each side strut. Using screws placed six inches on centers. Note that the center strut forms a split near the rear of the van body so as to accommodate the space necessary the rear door opening.
5. A secondary roof is then attached by placing 120-inch by 102-inch pieces of the sheeting over the struts across the van body. The but joints are connected using the “S” clips (item #3 Attachment A). The sheeting is then attached to the top of the struts with the screws spaced six inches on centers. See Attachment A, plan or top view.
6. The back of the ductwork is then capped of with a strip of the sheeting. See Attachment A, back view.
7. Two panels are need, one for each of the back doors of the van body. See Attachment B, top and bottom view.
8. “U” shaped struts are attached to each side of each read door. “Z” shaped struts are then attached down the center of each rear door. See Attachment B, top and bottom view, and back or plan view.
9. Across the top of each door, a 24-inch by 49-inch piece of sheeting is attached to the struts. Three inches below the top panel a 12-inch by 49-inch piece of sheeting is attached to the struts. Six inches below the second panel a 27-inch by 49-inch piece of sheeting is attached to the struts. In all instances the six inches on centers spacing is used for the screws.
Note that the panels do not extend the full length of the rear doors. Also note that the panels are open both top and bottom. The top of the door panels fit under the overhang of the roof top ductwork. The bottom is open to exhaust the remaining airflow in the area of maximum drag on the vehicle. See Attachment B, back or plan view. Also see figure number two.

### DESCRIPTION

The system consists of a series of struts placed on the topside of the van type truck body.

The struts are then covered with a secondary roof. Thus forming a system of ductwork that captures the airflow at the front end of the van. The air flow is conducted it to the rear of the van body where this system of duct work connects with a similar set of duct work down the back end of the truck body. See attachment A.

The rear ductwork consists, again, of several struts vertically down the back end of the van body. The struts are then covered to form ductwork as with the roof. The covering is slotted at varying intervals to allow the airflow to exit at different levels.

There are two separate panels, one for each rear door of the van body. In the case of an overhead back door in the van body, the struts are covered on both sides to form the ductwork.

The ductwork on the rear of the truck then conducts the airflow down the backside of the truck. The airflow is released though slots in the system and out the bottom of the system, in the area where the suction or vacuum has been generated by the forward movement of the truck. See attachment B.

As the speed of the truck increases, the vacuum behind the truck increases thus drawing more and more air though the system.

### SUMMARY

### Revised Jul. 15, 2008

A small reduction in the drag forces on a truck can make a dramatic difference. If these forces can reduced enough to effect a five to ten-percent in fuel mileage, saving in fuel and operating costs are greatly reduced.

Lets look at a small trucking company.

| | |
|---|---|
| Trucks | 20 |
| Mile/yr./truck | 150,000 |
| Av. MPG | 5.25 |
| Fuel Cost | $5.00/gal |
| Total Fuel Consumed | 571,428 gal |
| Total Cost | $2,857,140.00 |
| 5% savings | |
| Fuel | 28571 gals |
| Costs | $142,855.00 |
| 10% savings | |
| Fuel | 57,143 gals |
| Costs | $285,715.00 |

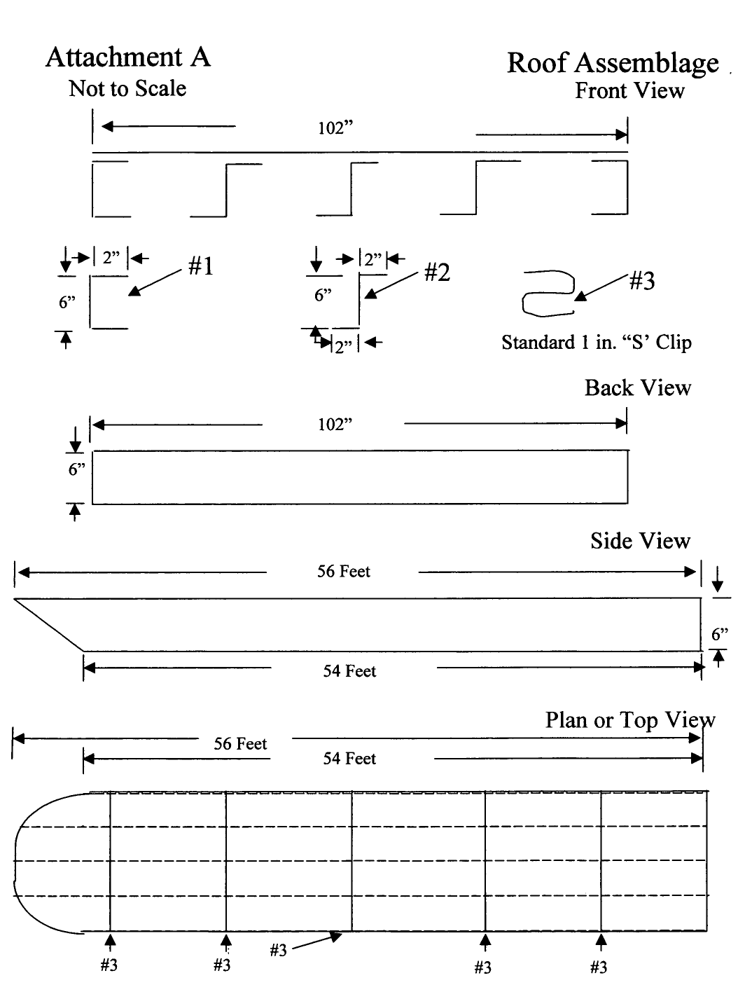

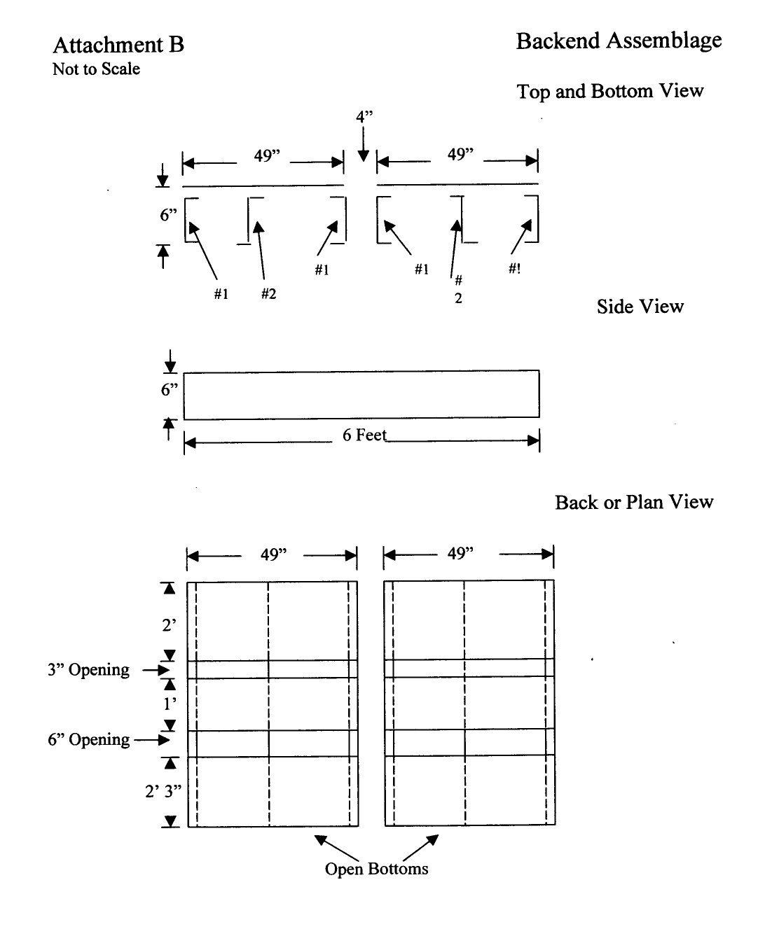

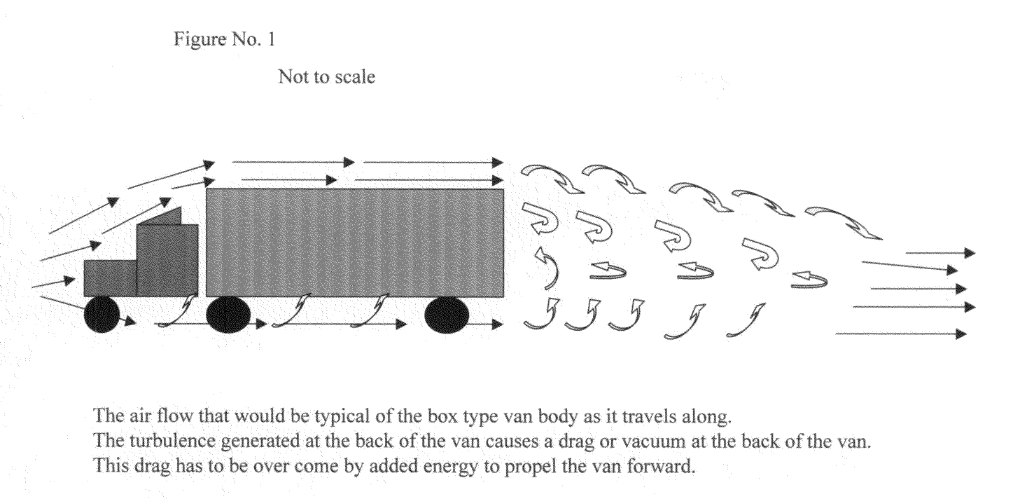

1. The movement of a box type van, weather it is a large semi-trailer truck or a smaller single unit vehicle, though the air at highway speeds causes a large disruption of the surrounding air as it moves though it. This disruption causes suction or vacuum immediately behind the vehicle. See FIG. 1. This suction can be so strong that a passenger car can move up close behind such a vehicle, disengage its transmission and the vehicle will pull the passenger car along with it. It is obvious that a lot of energy must be expended to overcome this drag on this type of vehicle.

2. Must effort to reduce the air resistance of this type of vehicle have been to try and break the airflow at the front end of the vehicle. More streamlined cab designs, over cab air damns, etc., etc,

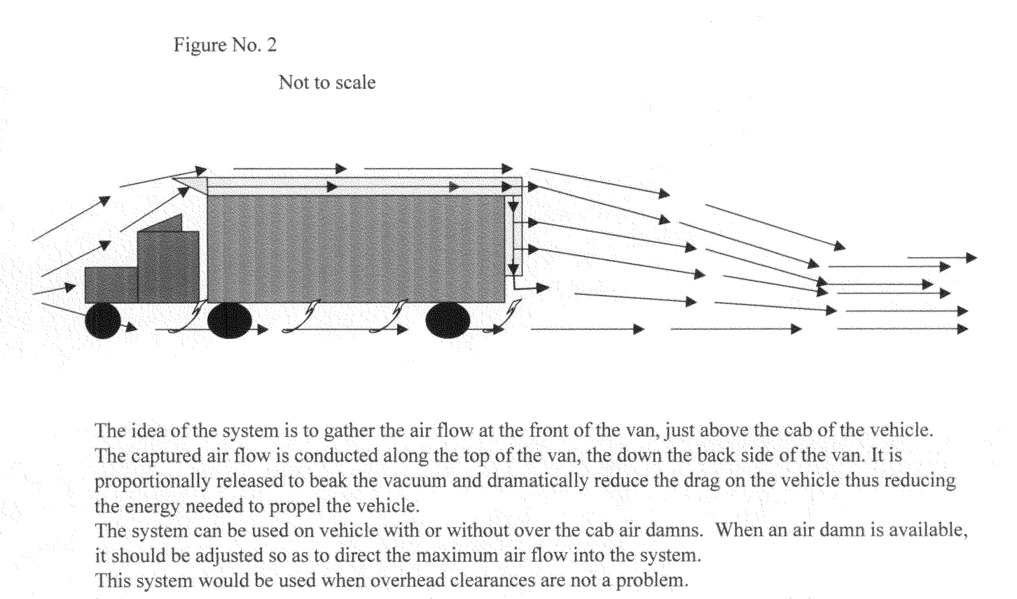

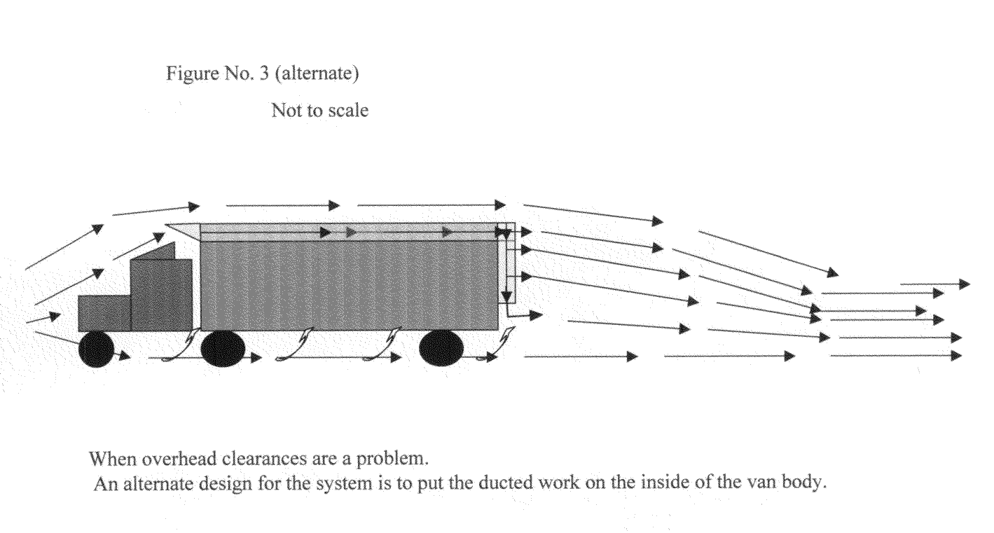

3. The idea of this system, is to gather airflow at the front end of the van and though a system of ducts, direct that airflow to the rear of the vehicle. Proportionally release the air across the cross section of the rear end of the vehicle thus dramatically reducing the drag on the vehicle by the suction. See FIG. 2.

4. The system is relatively lightweight. Adds less than five hundred pound to the gross weight of the vehicle.

5. No moving parts, thus very little maintenance.
